(19) United States
(12) Patent Application Publication
(10) Pub. No.: US 2006/0238646 A1
(43) Pub. Date: Oct. 26, 2006

(54) Encapsulating method for image sensing element

(76) Inventor: Ming-Te Cheng, Taoyuan (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/112,198

(22) Filed: Apr. 22, 2005

(51) Int. Cl. H04N 5/225

(52) U.S. Cl. 348/374

(57) ABSTRACT

An image sensing element encapsulating method includes the steps of mounting an image sensing element having thereon terminals on a substrate having thereon connecting terminals by surface mounting technique, combining the terminals on the image sensing element and the connecting terminals on the substrate, mounting a glass plate on the substrate to be opposite to the image sensing element, forming joints on the substrate and outside the image sensing element and forming a solder ball or a solder bump on each of the joints.

### BACKGROUND OF THE INVENTION

1. Field of the Invention

The present invention relates to an encapsulating method, and more particularly to an encapsulating method for an image sensing element.

2. Description of Related Art

With reference to FIG. 5, a conventional encapsulating method includes the steps of mounting an image sensing element (50) having thereon multiple terminals (51) on a substrate (40) having multiple connecting terminals (41) with a quantity corresponding to that of the terminals (51) of the image sensing element (50), mounting a frame (70) having two opposed open ends on the substrate (40) by heat pressing to enclose therein the image sensing element (50) and to protect the image sensing element (50), bonding wires (52) between the terminals (51) and the connecting terminals (41) and mounting a glass plate (60) on the frame (70) to encase the image sensing element (50) so that the image sensing element (50) is protected from different forms of contamination.

Although the conventional encapsulating method does have the function to encapsulate the image sensing element (50), existing shortcomings hinder the manufacture process and increase cost, which include:

Because the frame (70) is heat pressed onto the substrate, after the encapsulating method is completed, the image sensing element (50) is not able to fulfill the requirements of being lightweight, thin, short and compact.

As modern micro-chip technology advances, the wires between the terminals (51) and connecting terminals (41) are becoming more than ever. The pollutants caused by high speed mechanical operation of wire bonding pollutes the chip surface (the surface of the image sensing element) and results in that the image sensing element (50) is not able to present a required quality image after the encapsulating process is completed. Furthermore, if defective wire bonding is not detected before the entire process is completed and is later found to be unworkable in the testing phase, the entire assembly will be deemed as a scrap product.

Furthermore, complex and intricate wire bonding increases manufacture cost.

To overcome the shortcomings, the present invention tends to provide an encapsulating method to mitigate the aforementioned problems.

### SUMMARY OF THE INVENTION

The primary objective of the present invention is to provide an encapsulating method to allow the image sensing element to fulfill the requirements of being lightweight, thin, short and compact.

In one aspect of the present invention, the method in accordance with the present invention includes the steps of mounting the image sensing element on the substrate by a surface mounting technique, combining terminals of the image sensing element and connecting terminals of the substrate, mounting a glass plate on the substrate to be opposite to the image sensing element and forming joints on the substrate and outside the image sensing element, forming a solder ball or a solder bump on each of the joints.

Other objects, advantages and novel features of the invention will become more apparent from the following detailed description when taken in conjunction with the accompanying drawings.

### BRIEF DESCRIPTION OF THE DRAWINGS

FIG. 1 is a schematic view showing an image sensing element is to be mounted on a substrate;

FIG. 2 is a schematic view showing that after the connecting terminals of the substrate and the terminals of the image sensing element are combined by heating, a glass plate opposite to the image sensing element is mounted on the substrate;

FIG. 3 is a schematic view showing that solder balls are formed on joints outside the image sensing element;

FIG. 4 is a schematic view showing that solder bumps are formed on joints outside the image sensing element; and

FIG. 5 is a schematic view showing a conventional method for encapsulating image sensing element.

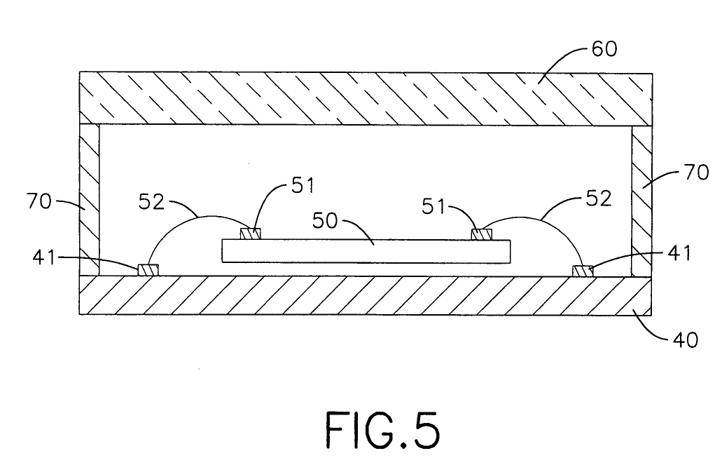

### DETAILED DESCRIPTION OF THE PREFERRED EMBODIMENT

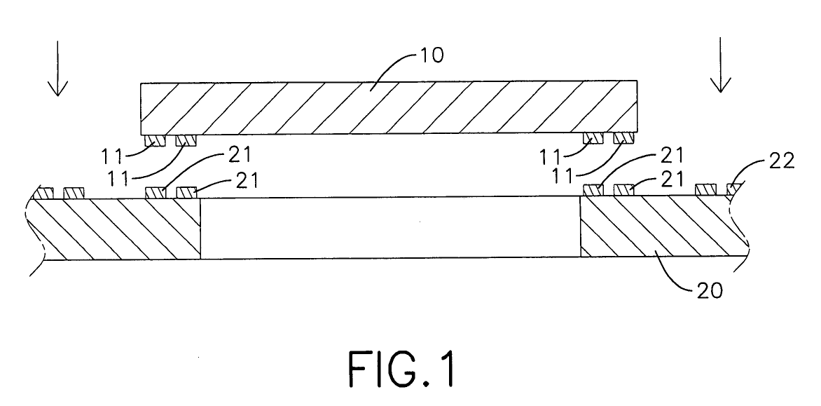

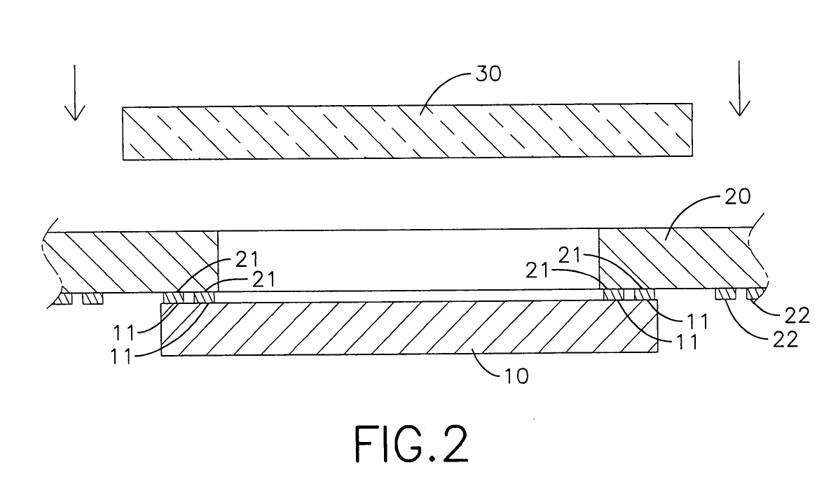

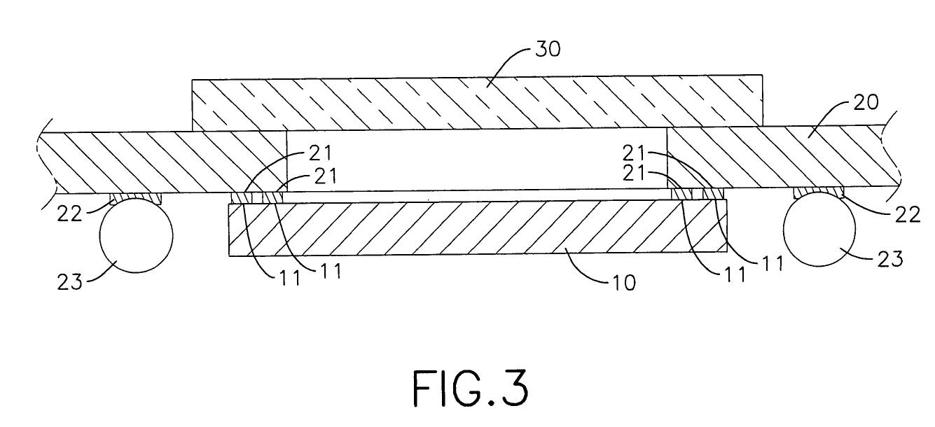

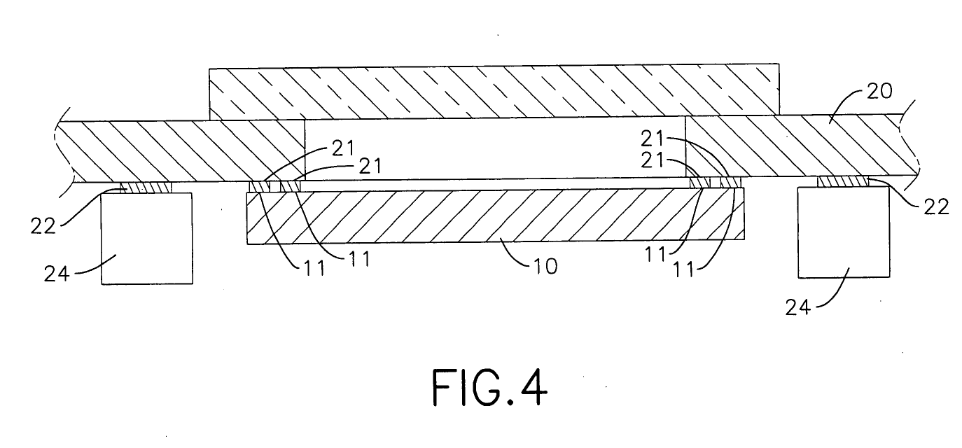

With reference to FIGS. 1 and 2, it is noted that the image sensing element encapsulating method in accordance with the present invention includes steps of mounting an image sensing element (10) having thereon terminals (11) on a substrate (20) having thereon multiple connecting terminals (21) by surface mounting technique (SMT). After the image sensing element (10) is mounted on the substrate (20) by SMT, the terminals (11) and the connecting terminals (21) are combined (the terminals (11) and the connecting terminals (21) are melted to combine with each other) by heating. Furthermore, a glass plate mounting step is added to the method so as to mount a glass plate (30) on the substrate (20) to be opposite to the image sensing element (10). Thereafter, with reference to FIG. 3 and still using FIG. 2 for reference, metal joints (22) are formed on the substrate (20) outside the image sensing element (10). Finally, with reference to FIG. 4, a solder ball (23) or a solder bump (24) is formed on each of the joints (22) for connection with circuits (not shown).

It is to be noted that the metal joints (22) forming step may be performed before the image sensing element mounting step in that after the joints (22) are formed, the image sensing element (10) mounting on the substrate (20) will not be influenced by the presence of the joints (22).

From the above steps, the method of the present invention has the following advantages:

The product including the substrate (20), the image sensing element (10), and the glass plate (30) is compact, lightweight, thin and short, which completely fulfills the modern technology requirements.

Because the connecting terminals (21) and the terminals (11) are combined, complex and intricate wire bonding processes are omitted, the manufacture cost is greatly reduced. Further, due to the omission of the wire bonding process, generation of pollutants is reduced and thus the image sensing element (10) is able to present high quality images.

Eliminating the frame (70) mounting step simplifies the method of the present invention and saves cost, which greatly increases the competitiveness of the product.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An image sensing element encapsulating method comprising the steps of:
mounting an image sensing element having thereon terminals on a substrate having thereon connecting terminals by a surface mounting technique;
combining the terminals on the image sensing element and the connecting terminals on the substrate;
mounting a glass plate on the substrate to be opposite to the image sensing element;
forming joints on the substrate and outside the image sensing element; and
forming a solder ball or a solder bump on each of the joints.

2. The method as claimed in claim 1, wherein the connecting terminals of the substrate and the terminals of the image sensing element are combined by heating.

3. An image sensing element encapsulating method comprising the steps of:
forming joints on a substrate;
mounting an image sensing element having thereon terminals on a substrate having thereon connecting terminals by a surface mounting technique, wherein the joints are outside the image sensing element;
combining the terminals on the image sensing element and the connecting terminals on the substrate;
mounting a glass plate on the substrate to be opposite to the image sensing element; and
forming a solder ball or a solder bump on each of the joints.

4. The method as claimed in claim 3, wherein the connecting terminals of the substrate and the terminals of the image sensing element are combined by heating.
